(19) United States
(12) Patent Application Publication
(10) Pub. No.: US 2016/0029119 A1
(43) Pub. Date: Jan. 28, 2016

(54) METHOD FOR CONTROLLING AN EXTENDED-RANGE ELECTRIC VEHICLE INCLUDING AN ELECTRONIC SOUND ENHANCEMENT SYSTEM

(71) Applicant: GM GLOBAL TECHNOLOGY OPERATIONS LLC, Detroit, MI (US)

(72) Inventors: Frank C. Valeri, Novi, MI (US); Douglas R. Koons, Brighton, MI (US); Scott M. Reilly, Southfield, MI (US)

(21) Appl. No.: 14/340,647

(22) Filed: Jul. 25, 2014

(51) Int. Cl. H04R 3/00

(52) U.S. Cl. CPC H04R 3/002; H04R 2499/13

(57) ABSTRACT

A method for controlling an extended-range electric vehicle including an internal combustion engine and an electronic sound enhancement system includes selecting a preferred engine order equalization, said preferred engine order equalization achieving a desired engine sound in a passenger compartment of the vehicle responsive to an operator input to an accelerator pedal and decoupled from actual engine operation responsive to a state of charge (SOC) of a propulsion battery. Sound is generated in the passenger compartment by the electronic sound enhancement system responsive to the preferred engine order equalization.

### TECHNICAL FIELD

This disclosure relates to an extended-range electric vehicle, and a system providing electronic sound enhancement.

### BACKGROUND

The statements in this section merely provide background information related to the present disclosure and may not constitute prior art.

An extended-range electric vehicle employs electric motors and, under certain circumstances, an internal combustion engine to generate propulsion torque. Vehicle operators perceive vehicle operation audibly, including perceiving engine operation in response to accelerator pedal position, a change in the accelerator pedal position or the state of charge of the high voltage (propulsion) battery.

### SUMMARY

A method for controlling an extended-range electric vehicle including an internal combustion engine and an electronic sound enhancement system includes selecting a preferred engine order equalization, said preferred engine order equalization achieving a desired engine sound in a passenger compartment of the vehicle responsive to an operator input to an accelerator pedal and decoupled from actual engine operation responsive to a state of charge (SOC) of a propulsion battery. Sound is generated in the passenger compartment by the electronic sound enhancement system responsive to the preferred engine order equalization.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

One or more embodiments will now be described, by way of example, with reference to the accompanying drawings, in which:

FIG. 1 is a schematic illustration of an embodiment of an extended-range electric vehicle (EREV) system that employs an electronic sound enhancement (ESE) system in a passenger compartment, in accordance with the disclosure;

FIG. 2 schematically illustrates an embodiment of an ESE control routine for operating an ESE system including dynamically changing powertrain sound quality in the passenger compartment responsive to operator commands and battery SOC in accordance with the disclosure; and

FIGS. 3-1 through 3-6 each graphically illustrate magnitudes of audible sound (db) in relation to sound frequency (Hz), including sound spectrums for audible sound experienced in a vehicle passenger compartment of an embodiment of the EREV system in response to powertrain operating conditions, including an actual sound spectrum, a desired sound spectrum, and a preferred engine order equalization selected to achieve the desired sound spectrum, in accordance with the disclosure.

### DETAILED DESCRIPTION

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

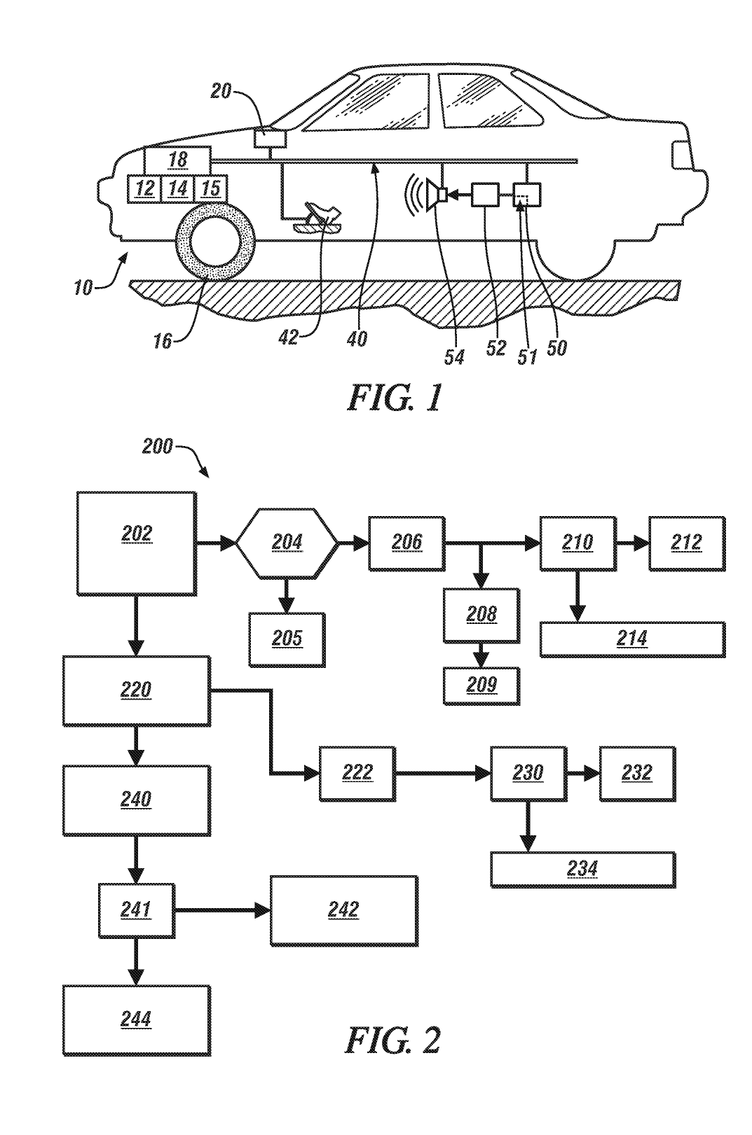

Referring now to the drawings, wherein the depictions are for the purpose of illustrating certain exemplary embodiments only and not for the purpose of limiting the same, FIG. 1 is a schematic illustration of an extended-range electric vehicle (EREV) system 10 that employs an electronic sound enhancement (ESE) system 50 in a passenger compartment 40. The EREV system 10 includes a powertrain system that employs an electric motor/generator 14, an internal combustion engine 12 and a drive unit 15 to generate and transfer tractive torque to a drive wheel 16 in response to operator commands determined via an accelerator pedal 42, a brake pedal and a transmission range selector. The motor/generator 14 electrically connects to an electric power system including an inverter and a high-voltage propulsion battery (battery) 18 to transfer electric power there between in one of either a charging mode or a discharging mode. In one embodiment, the internal combustion engine 12 is mechanically decoupled from the drive wheel 16 under all operating modes.

A controller 20 signally and operatively connects to each of the aforementioned elements and executes control routines to effect control in response to the operator commands. Monitored parameters including position and a time-rate change in position of the accelerator pedal 42, electric current flow, battery voltage and temperature can be employed to calculate a state-of-charge (SOC) of the battery 18, vehicle speed, engine speed and load and engine ON/OFF states among others.

The EREV system 10 operates in one of an electric vehicle (EV) mode, an EREV mode, and, in one embodiment, an engine-only mode. The EV mode includes operating the EREV system 10 using only the motor/generator 14 to generate tractive torque, with the internal combustion engine 12 in an OFF state, i.e., not rotating. The EREV mode includes operating the vehicle system using the motor/generator 14 to generate tractive torque, with the internal combustion engine 12 in an ON state. When the internal combustion engine 12 is in the ON state, it is generating torque that can be transferred to the drive wheel 16 for tractive effort and/or used for generating electric power that can be transferred to and stored in the battery 18 and/or transferred to the motor/generator 14 for tractive effort. The EREV system 10 can be coupled with a plug-in system that permits battery charging from an electric power grid when the vehicle is stationary. The EREV system 10 can operate in a charge-sustaining mode or a charge-depleting mode. The charge-sustaining mode includes an operating scheme that operates to maintain battery state-of-charge (SOC) within an allowable SOC window, e.g., 40%-60%. In this operating scheme, the vehicle operates in the EV mode so long as the battery SOC remains within the allowable SOC window, and switches to the EREV mode for charging the battery when the battery SOC approaches or falls below the allowable SOC window to maintain the battery SOC within the window. The charge-depleting mode includes an operating scheme that permits the battery state-of-charge (SOC) to fall to a depleted SOC level, e.g., 40%, with the vehicle operating in the EV mode.

The ESE system 50 includes a controller including non-volatile memory devices that contain executable ESE control routines and a plurality of engine order equalizations (EQs) 51. The ESE system 50 operatively connects to a speaker 54 through an amplifier, mixer, and other suitable components (amplifier) 52 that may be integrated into a vehicle infotainment system. The ESE system 50 dynamically controls and manages powertrain sound quality in the passenger compartment by executing ESE control routines, e.g., as described with reference to FIG. 2, to generate an engine order EQ 51. The engine order EQs 51 are sound spectrums in the form of magnitudes of audible sound (db) in relation to sound frequency (Hz). A sound spectrum is a representation of a sound in terms of the amount of vibration or intensity at each individual frequency over an audible range of frequencies, often presented as a graph of power or pressure in relation to frequency. For purposes of this disclosure, the audible range of frequencies includes frequencies from 20 Hz to 20 kHz. Each of the engine order EQs 51 corresponds to a rotational frequency of a crankshaft of the engine 12, i.e., engine speed. The engine order EQs 51 may be unique to a specific powertrain and vehicle type, e.g., sporty car, midsize sedan, or sport-utility vehicle. In one embodiment, the engine order EQs 51 may depend on the number of cylinders of the engine, engine displacement, engine aspiration (e.g., normally aspirated versus forced induction), engine calibration, selected operating mode, and/or an exhaust system of the vehicle.

The ESE system 50 executes ESE control routines to determine an engine base order sound and select a corresponding one of the engine order EQs 51 to mimic a desired sound from the engine 12. The selected engine order EQ 51 is communicated to the amplifier 52 and converted to electrical signals that drive the speaker 54, and the speaker 54 emits an audio signal that combines with the sound emitted from the engine 12. The audio signal emitted from the speaker 54 is superimposed on the sound emitted from the engine 12. The selected engine order EQ 51 enhances the engine sound by augmenting an actual engine base order sound emitted by the engine 12.

Control module, module, control, controller, control unit, processor and similar terms mean any one or various combinations of one or more of Application Specific Integrated Circuit(s) (ASIC), electronic circuit(s), central processing unit(s) (preferably microprocessor(s)) and associated memory and storage (read only, programmable read only, random access, hard drive, etc.) executing one or more software or firmware programs or routines, combinational logic circuit(s), input/output circuit(s) and devices, appropriate signal conditioning and buffer circuitry, and other components to provide the described functionality. Software, firmware, programs, instructions, routines, code, algorithms and similar terms mean any controller executable instruction sets including calibrations and look-up tables. The controller has a set of control routines executed to provide the desired functions. Routines are executed, such as by a central processing unit, and are operable to monitor inputs from sensing devices and other networked controllers, and execute control and diagnostic routines to control operation of actuators. Routines may be executed at regular intervals, for example each 100 microseconds or 3.125, 6.25, 12.5, 25 and 100 milliseconds during ongoing engine and vehicle operation. Alternatively, routines may be executed in response to occurrence of an event.

FIG. 2 schematically illustrates an embodiment of an ESE control routine 200 for operating an embodiment of the ESE system 50 described with reference to FIG. 1, including dynamically controlling powertrain sound quality in the passenger compartment responsive to operator commands while decoupling the powertrain sound quality experienced in the passenger compartment from sound generated by vehicle operation responsive to the battery SOC. The ESE control routine 200 thus decouples engine sound as experienced in the passenger compartment from sound generated by vehicle operation that is responsive to battery SOC. The ESE control routine 200 relates to logical operations that are preferably executed in the controller 20 as one or more algorithms and associated calibrations. Table 1 is provided as a key wherein the numerically labeled blocks and the corresponding functions are set forth as follows.

TABLE 1
FIG. 2

| BLOCK | BLOCK CONTENTS |
|---|---|
| 202 | Monitor SOC |
| 204 | SOC High |
| 205 | Engine OFF; ESE OFF |
| 206 | Engine ON |
| 208 | Engine ON due to ambient temperature |
| 209 | ESE On under some conditions |
| 210 | Engine ON - Evaluate APP to classify |
| | accelerator pedal dynamics as aggressive or |
| | normal |
| 212 | Aggressive pedal dynamics |
| | Execute EQ that achieves performance |
| | sound in ESE |
| 214 | Normal pedal dynamics |
| | Execute EQ that achieves purring sound in |
| | ESE |
| 220 | SOC Low; Engine ON |
| 222 | Engine ON, SOC near target SOC |
| | Charge sustaining mode |
| 230 | Evaluate APP to classify accelerator pedal |
| | dynamics as aggressive or normal |
| 232 | Execute EQ that achieves sporty sound in |
| | ESE |
| 234 | Execute EQ that achieves purring sound in |
| | ESE |
| 240 | Engine ON, SOC << target SOC |
| 241 | Evaluate APP to classify accelerator pedal |
| | dynamics as aggressive or normal |
| 242 | Execute EQ that achieves sporty sound in |
| | ESE |
| 244 | Execute EQ that achieves purring sound in |
| | ESE |

The ESE control routine 200 operates by regularly and ongoingly monitoring SOC of the high voltage battery that provides electric power to the electric motor/generator and monitoring operator input to the accelerator pedal, including an accelerator pedal position (APP) (202). When the SOC is high, i.e., greater than 60% mode (204) in one embodiment, the system determines whether the internal combustion engine is in an ON state or an OFF state. When the internal combustion engine is in the OFF state (205), operation of the ESE system is suspended and this iteration of the ESE control routine 200 ends with no further action. When the internal combustion engine is in the ON state (206), the system determines whether it is in the ON state in response to ambient temperature conditions (208), such as may be necessary to operate passenger compartment heating, ventilation and cooling systems. The ESE system may be activated under certain conditions when the internal combustion engine is in the ON state in response to ambient temperature conditions (209). When the internal combustion engine is in the ON state for reasons other than in response to ambient temperature conditions, such as to provide direct tractive power or to provide mechanical power that is transformed to electric power and employed by the motor/generator to generate tractive power, operator commands to the accelerator pedal are monitored, with the APP and a time-rate change in the APP evaluated to classify accelerator pedal dynamics as either aggressive or normal (210). The APP is considered to be low or normal and the accelerator pedal dynamics are considered normal or non-aggressive when the APP is in a range between 5% and 50% of a wide-open throttle position in one embodiment. The APP is considered to be high and/or the accelerator pedal dynamics are considered aggressive when the APP is in a range that is greater than 50% of a wide-open throttle position in one embodiment. Classifying the accelerator pedal dynamics as either aggressive or normal is application-specific and calibratable.

When the accelerator pedal dynamics are considered normal, the ESE system selects and executes an engine order equation (EQ) that achieves an audible engine sound reminiscent of a low-level purring sound while accounting for actual, presently occurring engine and engine-related sound (214). This includes generating a first magnitude/frequency spectrum corresponding to the audible engine sound reminiscent of a low-level purring sound in the passenger compartment and generating a second magnitude/frequency spectrum corresponding to the actual, presently occurring engine and engine-related sound. Each of the selected engine order EQs is a differential sound spectrum that is determined based upon differences between the first and corresponding second magnitudes across the audible frequency range. The process for selecting and executing an engine order EQ that achieves an engine sound while accounting for actual, presently occurring engine and engine-related sound is the same for each of the selected engine and engine-related sound. When the accelerator pedal dynamics are considered aggressive, the ESE system selects and executes an engine order EQ that achieves an engine sound reminiscent of an accelerating engine performance sound while accounting for actual, presently occurring engine and engine-related sound (212).

When the system is operating with the engine ON with the SOC near the target SOC (220, 222), the powertrain system operates in a charge-sustaining mode to maintain the SOC at or near the target SOC. The operator commands to the accelerator pedal are monitored, with the APP and a time-rate change in the APP evaluated to classify accelerator pedal dynamics as either aggressive or normal (230). When the accelerator pedal dynamics are considered normal, the ESE system selects and executes an engine order EQ that achieves an engine sound reminiscent of a low-level purring sound while accounting for actual, presently occurring engine and engine-related sound (234). When the accelerator pedal dynamics are considered aggressive, the ESE system selects and executes an engine order EQ that achieves an engine sound reminiscent of a performance sound while accounting for actual, presently occurring engine and engine-related sound (232).

When the system is operating with the engine ON with the SOC significantly less than the target SOC (240, 241), the powertrain system continues to operate in a charge-sustaining mode. The engine may produce significant noise during charging operation because the engine may be operating at high speed to charge the propulsion battery towards the target SOC. The operator commands to the accelerator pedal are monitored, with the APP and a time-rate change in the APP evaluated to classify accelerator pedal dynamics as either aggressive or normal (241). When the accelerator pedal dynamics are considered normal, the ESE system selects and executes an engine order EQ that achieves an engine sound reminiscent of a low-level purring sound while accounting for actual, presently occurring engine and engine-related sound (244). When the accelerator pedal dynamics are considered aggressive, the ESE system selects and executes an engine order EQ that achieves an engine sound reminiscent of a performance sound while accounting for actual, presently occurring engine and engine-related sound (242).

Thus, under conditions of steady state cruising with a low accelerator pedal input approaching a grade in the road, the SOC dictates engine operation, and the ESE control routine 200 monitors the SOC and other variables as the basis for selecting and executing one of the engine order EQs to achieve a desired engine sound in a passenger compartment of the vehicle responsive to the operator input to the accelerator pedal and decoupled from engine sound associated with operation of the engine dictated by the SOC. When the battery SOC is low and approaching a minimum target SOC with engine operation dictated in the charge sustaining mode, the ESE system selects and executes an engine order EQ identified as EQ1 to achieve a purring sound in response to a normal operator input to the accelerator pedal while accounting for the engine operation in the charge sustaining mode. When the battery SOC is low but significantly greater than the minimum target SOC and engine operation is commanded for other reasons during operation in the charge depleting mode, the ESE system selects and executes an engine order EQ identified as EQ3 to achieve the purring sound in response to a normal operator input to the accelerator pedal while accounting for the engine operation. Both EQ1 and EQ3 can deliver the same purring sound, thus resulting in a uniform, unchanging purring sound in the passenger compartment decoupled from sound associated with operation of the vehicle across a range in engine speeds associated with charging operation.

When the battery SOC is low and approaching a target SOC, engine operation can be dictated with operation in the charge sustaining mode with engine on (222), the ESE system selects and executes an engine order EQ identified as EQ2 to achieve a sporty sound in response to an aggressive operator input to the accelerator pedal (230, 232), and when the battery SOC is low but significantly less than the target SOC, engine operation is dictated by operating in a more aggressive charge mode (higher RPM) with the engine ON, the ESE system selects and executes an engine order EQ identified as EQ4 to achieve the sporty sound in response to an aggressive operator input to the accelerator pedal. However both EQ2 and EQ4 can deliver the same sound, thus resulting in continuous sporty sound in the passenger compartment decoupled from sound associated with engine operation over a range in engine speeds associated with charging operation.

When the battery SOC is high, engine operation can be dictated while operating in the charge depleting mode. The ESE system selects and executes an engine order EQ identified as EQ5 to achieve a performance sound in response to an aggressive operator input to the accelerator pedal. The performance sound generated by the engine order EQ identified as EQ5 is similar to but even greater in magnitude and character of sound as compared to the sporty sound (EQ2, EQ4) to match the increased vehicle performance operating capabilities because of high SOC. Likewise, when the battery SOC is high, operation can be dictated by operating in the charge depleting mode with engine on, the ESE system 50 selects and executes an engine order EQ identified as EQ6 to achieve a purring sound in response to a normal operator input to the accelerator pedal. The engine order EQs identified as EQ1, EQ3 and EQ6 can deliver the same purring sound, thus resulting in a uniform, unchanging purring sound in the passenger compartment across a range in engine speeds, driver modes, pedal response and SOC in one embodiment. Monitoring the SOC allows the ESE system to predict engine autostarting, with a corresponding ramping in of the ESE system to enhance sound associated with engine starting. Furthermore, other inputs can be employed to determine if the ESE system 50 is active in addition to SOC, including ambient temperature, coolant temperature and operator-selected vehicle mode.

Operation of an embodiment of the ESE system under different operating conditions is described with reference to FIGS. 3-1 through 3-6. Each of FIGS. 3-1 through 3-6 are sound spectrums showing magnitudes of sound (db) 308 on a vertical axis in relation to sound frequency (Hz) 300 on a horizontal axis. The sound spectrums are consolidated to indicate a sound magnitude for each of a plurality of frequency ranges. This consolidation of the sound magnitude within the aforementioned frequency ranges is non-limiting, and is provided to assist in explaining the concepts described herein.

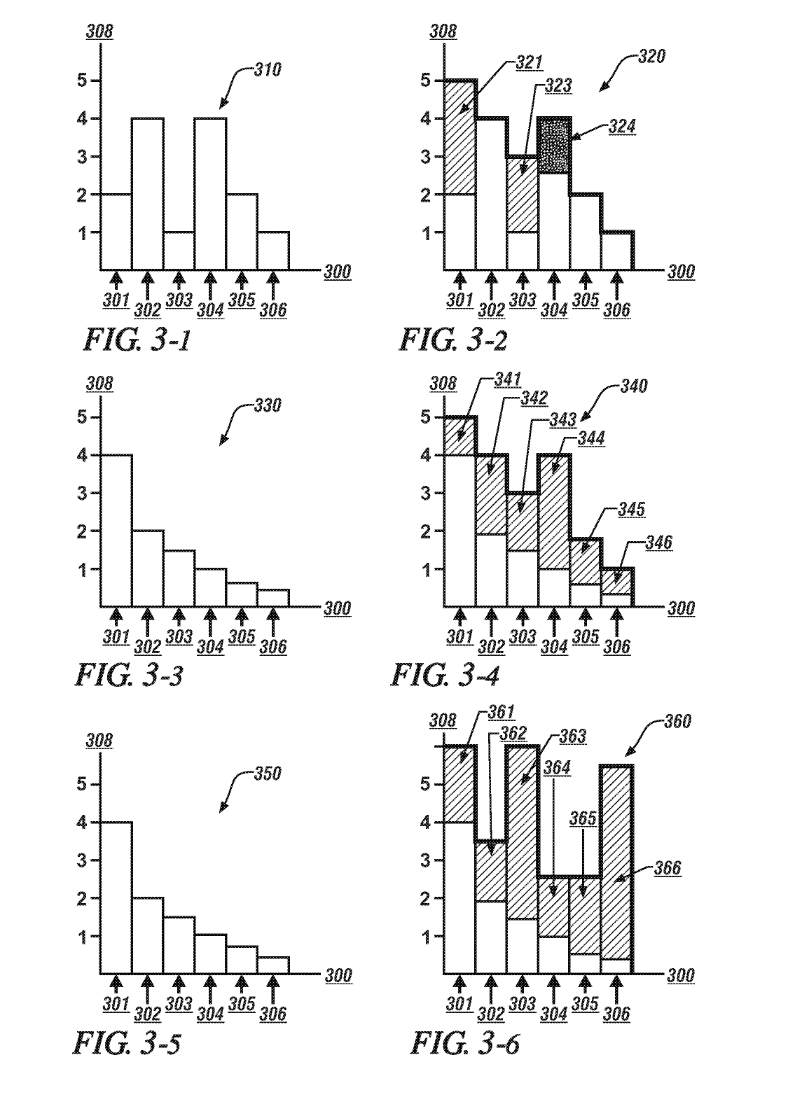

FIG. 3-1 graphically shows a first actual sound spectrum 310, which represents sound experienced in a vehicle passenger compartment of an embodiment of the EREV system 10 in response to a first set of powertrain operating conditions that are responsive to an engine speed/load operating point, battery SOC, and monitored accelerator pedal dynamics. The first actual sound spectrum 310 depicts a base set of orders of sound associated with frequency ranges and generated by operation of the internal combustion engine, i.e., the actual, presently occurring engine and engine-related sound that is consolidated to indicate a sound magnitude for each of a plurality of any number of powertrain orders. Each engine order can cover a unique frequency range or be overlapping each other in frequency or skip whole bands of the frequency range if desired. FIG. 3-1 is an example showing six orders of sound associated with frequency ranges 301, 302, 303, 304, 305 and 306 over the audible range from 20 Hz to 20 KHz.

FIG. 3-2 graphically shows the first actual sound spectrum 310 and a first desired sound spectrum 320, wherein the first desired sound spectrum 320 is a graphical representation of an engine order EQ having a monotonically decreasing magnitude of sound with increasing frequency, which is a schematic example of a purring sound contrived for purposes of illustration only. It is appreciated that the schematic example of the purring sound is for purposes of illustrating the concepts described herein and does not represent an actual purring sound profile that might be implemented on-vehicle. The ESE system selects and executes a preferred engine order EQ, e.g., EQ6 to generate sound in the vehicle passenger compartment that achieves the purring sound associated with the first desired sound spectrum 320 while accounting for the first actual sound spectrum 310 in accordance with the ESE control routine 200. The preferred engine order EQ, e.g., EQ6 is a differential sound spectrum that includes sound components 321 and 323, wherein sound component 321 is a predetermined magnitude of sound at frequency range 301 and sound component 323 is a predetermined magnitude of sound at frequency range 303 to supplement the deficiencies in sound magnitudes between the first desired sound spectrum 320 and the first actual sound spectrum 310 at the corresponding frequency ranges. The first actual sound spectrum 310 at frequency range 304 exceeds the corresponding magnitude of sound at the desired sound spectrum 320, as indicated by sound component 324, which remains a residual sound element generated by actual engine operation.

FIG. 3-3 graphically shows a second actual sound spectrum 330, which represents sound in a vehicle passenger compartment of an embodiment of the EREV system 10 in response to a second set of powertrain operating conditions that are responsive to an engine speed/load operating point, battery SOC, and monitored accelerator pedal dynamics. The second actual sound spectrum 330 depicts another baseline sound profile that is consolidated to indicate a sound magnitude for each of the frequency ranges 301, 302, 303, 304, 305 and 306 over the audible spectrum from 20 Hz to 20 KHz. This consolidation of the sound magnitude within the aforementioned frequency ranges is provided to assist in explaining the concepts described herein.

FIG. 3-4 graphically shows the second actual sound spectrum 330 and a second desired sound spectrum 340 wherein the second desired sound spectrum 340 is the monotonically decreasing magnitude of sound with increasing frequency, i.e., the purring sound, which is selected based upon a normal, mild or low operator input to the accelerator pedal and other factors. The ESE system selects and executes a preferred engine order EQ, e.g., EQ1, to generate sound in the vehicle passenger compartment that achieves the purring sound associated with the second desired sound spectrum 340 while accounting for the actual sound spectrum 330 in accordance with the ESE control routine 200. The preferred engine order EQ, e.g., EQ1 is a differential sound spectrum that includes sound components 341, 342, 343, 344, 345 and 346, which are predetermined magnitudes of sound at frequency ranges 301, 302, 303, 304, 305 and 306, respectively, to supplement the deficiencies in sound magnitudes between the second desired sound spectrum 340 and the second actual sound spectrum 330 at the corresponding frequency ranges.

FIG. 3-5 graphically shows a third actual sound spectrum 350, which is analogous to the second actual sound spectrum 330 and represents sound in a vehicle passenger compartment of an embodiment of the EREV system 10 in response to a second set of powertrain operating conditions that are responsive to an engine speed/load operating point, propulsion battery SOC, and monitored accelerator pedal dynamics. The third actual sound spectrum 350 depicts a non-monotonically decreasing magnitude of sound with increasing frequency that is consolidated to indicate a sound magnitude for each of the contiguous frequency ranges 301, 302, 303, 304, 305 and 306 over the audible range from 20 Hz to 20 KHz. This consolidation of the sound magnitude within the aforementioned frequency ranges is provided to assist in explaining the concepts described herein.

FIG. 3-6 graphically shows the third actual sound spectrum 350 and a third desired sound spectrum 360 wherein the third desired sound spectrum 360 represents a sporty engine base order sound, which is selected based upon an aggressive operator input to the accelerator pedal, propulsion battery SOC and other factors. The ESE system selects and executes a preferred engine order EQ, e.g., EQ2 to generate sound in the vehicle passenger compartment that achieves the sporty sound associated with the third desired sound spectrum 360 while accounting for the third actual sound spectrum 350 in accordance with the ESE control routine 200. The preferred engine order EQ, e.g., EQ2 is a differential sound spectrum that includes sound elements 361, 362, 363, 364, 365 and 366, which are predetermined magnitudes of sound at frequency ranges 301, 302, 303, 304, 305 and 306, respectively, to supplement the deficiencies in sound magnitudes between the desired sound spectrum 360 and the actual sound spectrum 350 at the corresponding frequency ranges. Thus, the ESE control routine 200 selects and executes different preferred engine order EQs to generate different sounds in the vehicle passenger compartment depending upon the requirements of the system.

1. A method for controlling an extended-range electric vehicle including an internal combustion engine and an electronic sound enhancement system, comprising:
selecting a preferred engine order equalization, said preferred engine order equalization achieving a desired engine sound in a passenger compartment of the vehicle responsive to an operator input to an accelerator pedal and decoupled from actual engine operation responsive to a state of charge (SOC) of a propulsion battery; and
generating, by the electronic sound enhancement system, sound in the passenger compartment responsive to the preferred engine order equalization.

2. The method of claim 1, wherein selecting the preferred engine order equalization comprises selecting one of a plurality of engine order equalizations to generate the desired engine sound in the passenger compartment that accounts for presently occurring engine sound associated with the actual engine operation.

3. The method of claim 2, wherein selecting one of a plurality of engine order equalizations to generate the desired engine sound in the passenger compartment that accounts for presently occurring engine sound associated with the actual engine operation comprises:
determining a first sound spectrum corresponding to the desired engine sound in the passenger compartment;
determining a second sound spectrum corresponding to the presently occurring engine sound; and
selecting the preferred engine order equalization comprising a differential sound spectrum based upon differences between the first and corresponding second magnitudes for each frequency of the first and second sound spectrums.

4. The method of claim 1, further comprising discontinuing employing the electronic sound enhancement system to generate any sound in the passenger compartment of the vehicle when the extended-range electric vehicle is operating in an electric vehicle mode/operating with the engine in an OFF state.

5. The method of claim 1, wherein selecting a preferred engine order equalization comprises selecting a preferred engine order equalization associated with a purring sound responsive to a non-aggressive operator input to the accelerator pedal.

6. The method of claim 1, wherein selecting a preferred engine order equalization comprises selecting a preferred engine order equalization associated with a sporty engine base order sound responsive to a non-aggressive operator input to the accelerator pedal.

7. The method of claim 1, wherein selecting a preferred engine order equalization comprises selecting a preferred engine order equalization associated with a sporty engine base order sound responsive to an aggressive operator input to the accelerator pedal.

8. The method of claim 1, wherein selecting a preferred engine order equalization comprises selecting a preferred engine order equalization associated with a performance engine base order sound responsive to an aggressive operator input to the accelerator pedal.

9. The method of claim 1, wherein selecting a preferred engine order equalization comprises selecting a preferred engine order equalization associated with a purring engine base order sound responsive to an aggressive operator input to the accelerator pedal.

10. The method of claim 1, further comprising employing the electronic sound enhancement system to generate enhancement sound in the passenger compartment of the vehicle when the extended-range electric vehicle is transitioning between an engine ON state and an engine OFF state.

11. The method of claim 1, further comprising generating, by the electronic sound enhancement system, sound in the passenger compartment at higher magnitude levels and character when in one of a performance mode or a sporty mode in the passenger compartment of the vehicle to mask system sounds.

12. The method of claim 1, further comprising generating, by the electronic sound enhancement system, sound in the passenger compartment responsive to a preferred engine order equalization when the engine is in the ON state responsive to a low ambient temperature.

13. The method of claim 1, further comprising generating, by the electronic sound enhancement system, sound in the passenger compartment responsive to the preferred engine order equalization when the engine is in the ON state responsive to a disengaged hood latch.

14. A method for controlling an extended-range electric vehicle including an internal combustion engine and an electronic sound enhancement system, comprising:
monitoring, by a controller, a state of charge (SOC) of a propulsion battery and an operator input to an accelerator pedal;
selecting a preferred engine order equalization that achieves a desired engine sound in a passenger compartment of the vehicle responsive to the operator input to the accelerator pedal, said desired sound associated with the preferred engine order equalization decoupled from actual engine sound; and
generating sound in the passenger compartment responsive to the preferred engine order equalization employing the electronic sound enhancement system.

15. The method of claim 14, wherein selecting a preferred engine order equalization that achieves a desired engine sound in a passenger compartment of the vehicle responsive to the operator input to the accelerator pedal, said desired sound associated with the preferred engine order equalization decoupled from actual engine sound comprises selecting one of a plurality of engine order equalizations to generate the desired engine sound in the passenger compartment accounting for the actual engine sound.

16. The method of claim 14, wherein selecting one of a plurality of engine order equalizations to generate the desired engine sound in the passenger compartment accounting for the actual engine sound comprises:
determining a first sound spectrum corresponding to the desired engine sound;
determining a second sound spectrum corresponding to the actual engine sound; and
selecting the preferred engine order equalization comprising a differential sound spectrum based upon differences between the corresponding first and second magnitudes for each frequency of the first and second sound spectrums.
